(19) United States
(12) Patent Application Publication
(10) Pub. No.: US 2014/0013559 A1
(43) Pub. Date: Jan. 16, 2014

(54) PRESS-FIT MECHANISM

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: GUO-BAI YUAN, Shenzhen (CN); YONG LIU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/847,015

(22) Filed: Mar. 19, 2013

(30) Foreign Application Priority Data
Jul. 11, 2012 (CN) 2012102383860

(51) Int. Cl. B23P 19/04

(52) U.S. Cl. CPC B23P 19/04
USPC 29/281.1

(57) ABSTRACT

A press-fit mechanism capable of mounting magnetic materials on a workpiece, includes a base plate, a transmission assembly, a resisting assembly, a loading assembly, a transferring assembly and a sucking assembly. The transmission assembly is slidably mounted on the base plate. The resisting assembly and the loading assembly are mounted on the transmission assembly. the resisting assembly includes a driving member and a resisting plate connected to the driving member. The transferring assembly is located between the resisting assembly and the loading assembly. The sucking assembly is mounted on the base plate. The driving member drives the resisting plate to resist the magnetic materials from the transferring assembly toward the loading assembly, the loading assembly is driven by the transmission assembly toward the sucking assembly, then the loading assembly releases the magnetic materials, the sucking assembly sucks the magnetic materials and places the magnetic materials on the workpiece.

### BACKGROUND

1. Technical Field

The present disclosure relates to press-fit mechanisms, and particularly to a press-fit mechanism for loading magnetic materials.

2. Description of Related Art

Human labor is employed to transfer magnetic materials to multiple receiving portions of a workpiece. However, when high loading precision is acquired, the efficiency may be low. Especially when the magnetic materials should be loaded in a particular manner, such as a positive magnetic material and a negative magnetic material in an interval order, human errors often occur. In addition, the magnetic materials interfere with each other due to the magnetism, it is difficult to control the magnetic materials and the loading efficiency may be further reduced.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a press-fit mechanism.

FIG. 2 is similar to FIG. 1, but viewed from another aspect.

FIG. 3 is an exploded, isometric view of the press-fit mechanism of FIG. 1.

FIG. 4 is similar to FIG. 3, but viewed from another aspect.

FIG. 5 is a cross-sectional view of the press-fit mechanism of FIG, 1, taken along line V-V.

FIG. 6 is an enlarged view of circled portion VI of FIG. 5.

### DETAILED DESCRIPTION

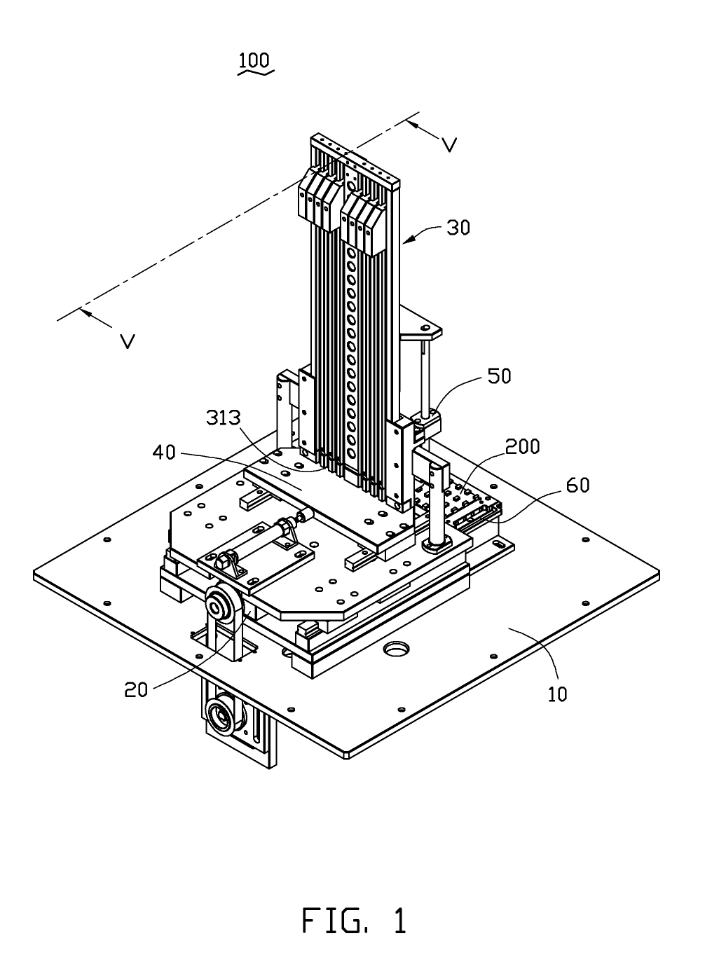

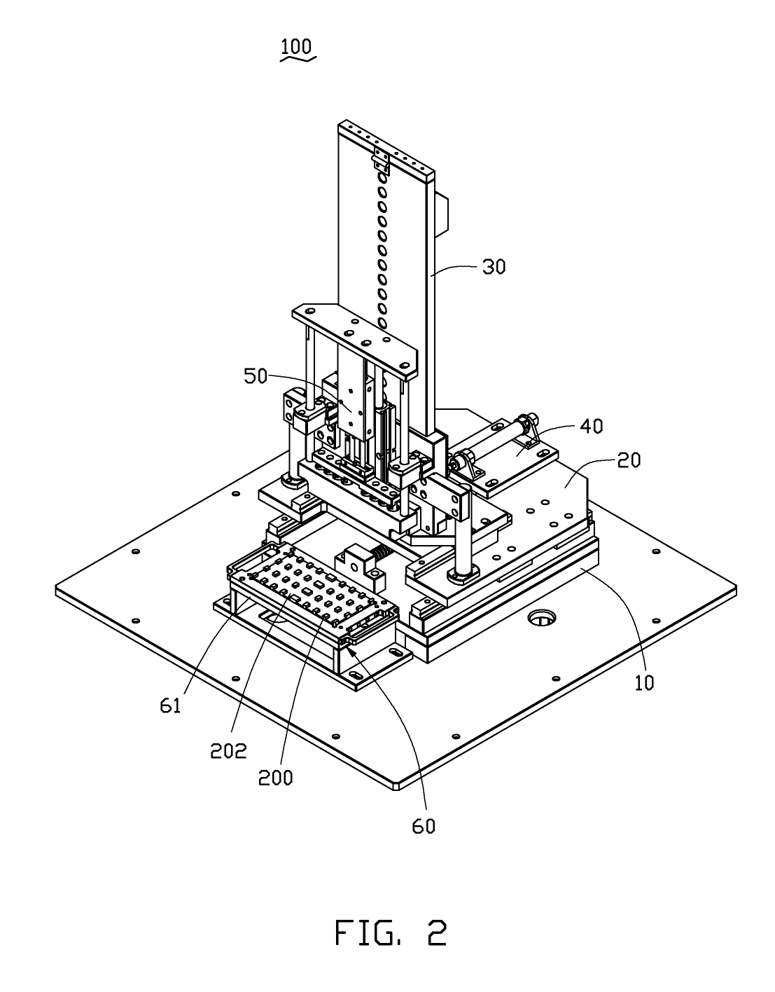

Referring to FIGS. 1 and 2, an embodiment of a press-fit mechanism 100 is employed to transfer magnetic materials to a plurality of receiving portions 202 of a workpiece 200. In the embodiment, the magnetic materials are permanent magnets and loaded on the workpiece in such a manner that a positive magnet and a negative magnet are in an interval order. The press-fit mechanism 100 includes a base plate 10, a transmission assembly 20, a transferring assembly 30, a resisting assembly 40, a loading assembly 50, and a sucking assembly 60. The transmission assembly 20 is mounted on the base plate 10. The transferring assembly 30 and the resisting assembly 40 are mounted on the transmission assembly 20 and adjacent to each other. The loading assembly 50 is mounted on the transmission assembly 20 and located at a side of the transferring assembly 30 opposite to the resisting assembly 40. The sucking assembly 60 is mounted on the base plate 10 and located below the loading assembly 50. The transferring assembly 30 is employed to serve permanent magnets to the transmission assembly 20, the resisting assembly 40 pushes the permanent magnets on the transmission assembly 20 toward the loading assembly 50. The loading assembly 50 sucks the permanent magnets and is moved by the transmission assembly 20 toward the sucking assembly 60. The sucking assembly 60 takes the permanent magnets from the loading assembly 50 and positions them on the workpiece 200 together with the loading assembly 50.

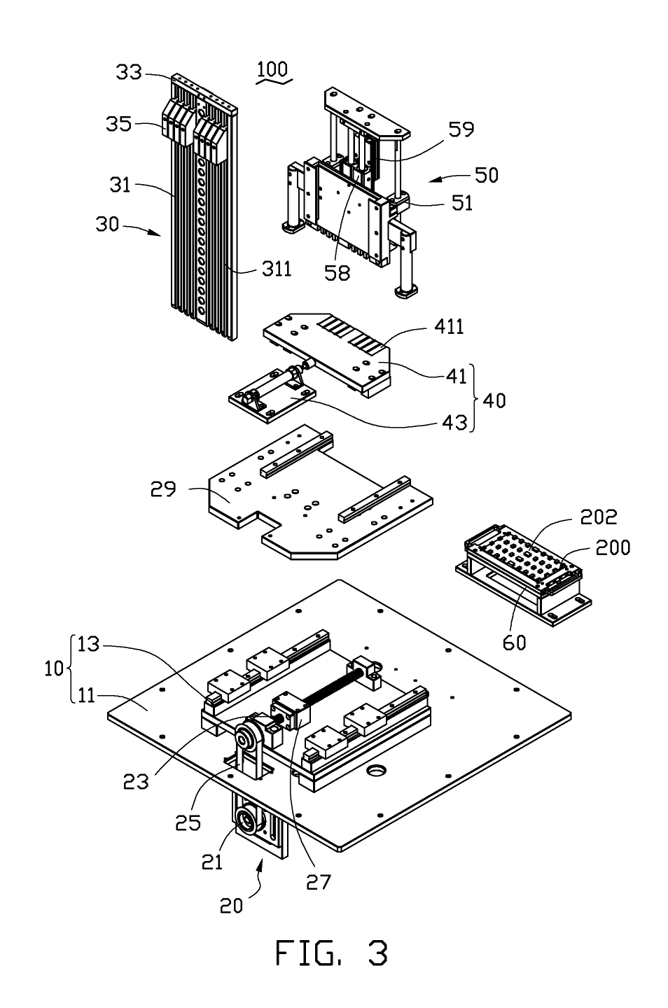

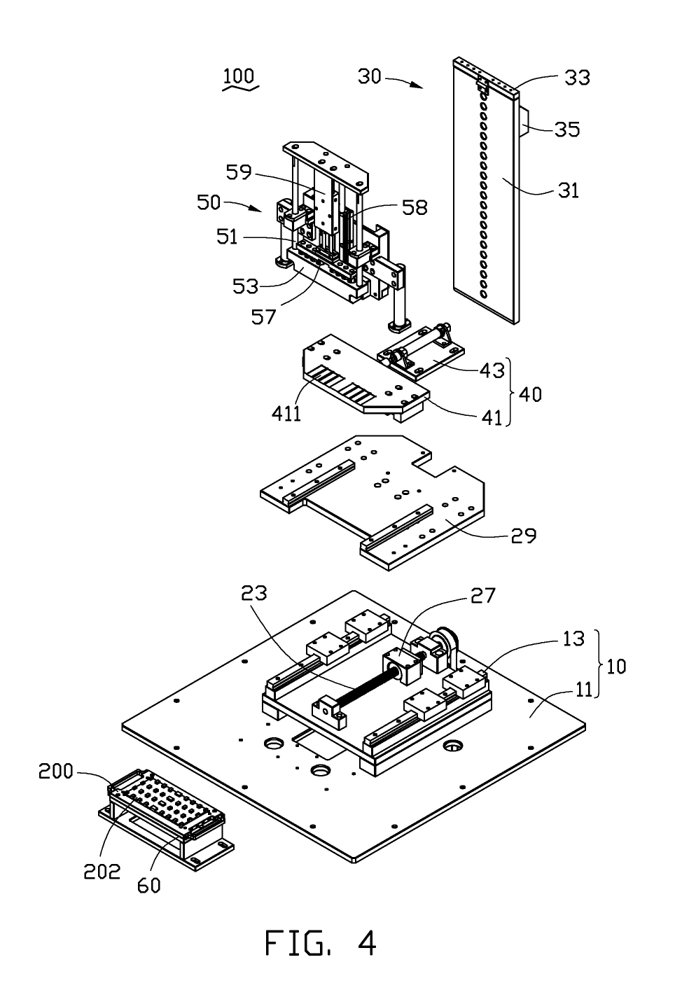

Referring to FIGS. 3 and 4, the base plate 10 includes a bottom plate 11 and a pair of guiding members 13 on the bottom plate 11. The pair of guiding members 13 are parallel to each other.

The transmission assembly 20 includes a driving member 21, a screw leading member 23, a transmission belt 25, a nut 27 and a base member 29. The driving member 21 is mounted on a bottom of the bottom plate 11 opposite to the pair of guiding members 13. The screw leading member 23 is mounted between the pair of guiding members 13. The transmission belt 25 extends through the bottom plate 11 and is sleeved on the driving member 21 and the screw leading member 23. The base member 29 is parallel to the bottom plate 11 and slidably engages with the pair of guiding members 13. The nut 27 is fixed to the base member 29 and engages with the screw leading member 23. The driving member 21 is capable of rotating the screw leading member 23 via the transmission belt 25, then the screw leading member 23 drives the base member 29 to slide along the pair of the guiding members 13 via the nut 27.

The transferring assembly 30 includes a clamping plate 31, a press cover 33 and a plurality of clamping blocks 35 slidably received in the clamping plate 31. The clamping plate 31 is perpendicular to the base member 29 and fixed to the base member 29. The clamping plate 31 defines a plurality of elongated clamping grooves 311 thereon. The extending direction of each of the clamping grooves 311 is perpendicular to the base member 29. The press cover 33 is detachably mounted a top end of the clamping plate 31 opposite to the base member 29. The plurality of permanent magnets is received in the plurality of clamping groves 311. The permanent magnets received in same clamping groove 311 have a same polarity, the permanent magnets received in adjacent ones of the clamping grooves 311 have an opposite polarity. The clamping plate 31 and the base member 29 forms a resisting space 313 therebetween. The resisting space 313 communicates with the plurality of the clamping grooves 311. The plurality of the clamping blocks 35 are received in the corresponding clamping grooves 311 and employed to press the permanents magnets, respectively. The press cover 33 is equipped with a plurality of strong magnets corresponding to the plurality of clamping grooves 311. The clamping plate 31 is made of non-magnetic materials.

The resisting assembly 40 includes a resisting plate 41, and a driving member 43. The resisting plate 41 is slidably mounted on the base member 29 adjacent to the clamping plate 31. The driving member 43 is mounted on the base member 29 and connected to the resisting plate 41. The resisting plate 41 is driven by the driving member 43 to enter the resisting space 313, then pushes the permanent magnets received in the resisting space 313. The resisting plate 41 defines a plurality of peeling grooves 411 at an end thereof communicating with the resisting space 313. The peeling groove 411 is a stepped groove for receiving a portion of corresponding one permanent magnet, a depth of the peeling groove 411 is greater than half of a height of the permanent magnet.

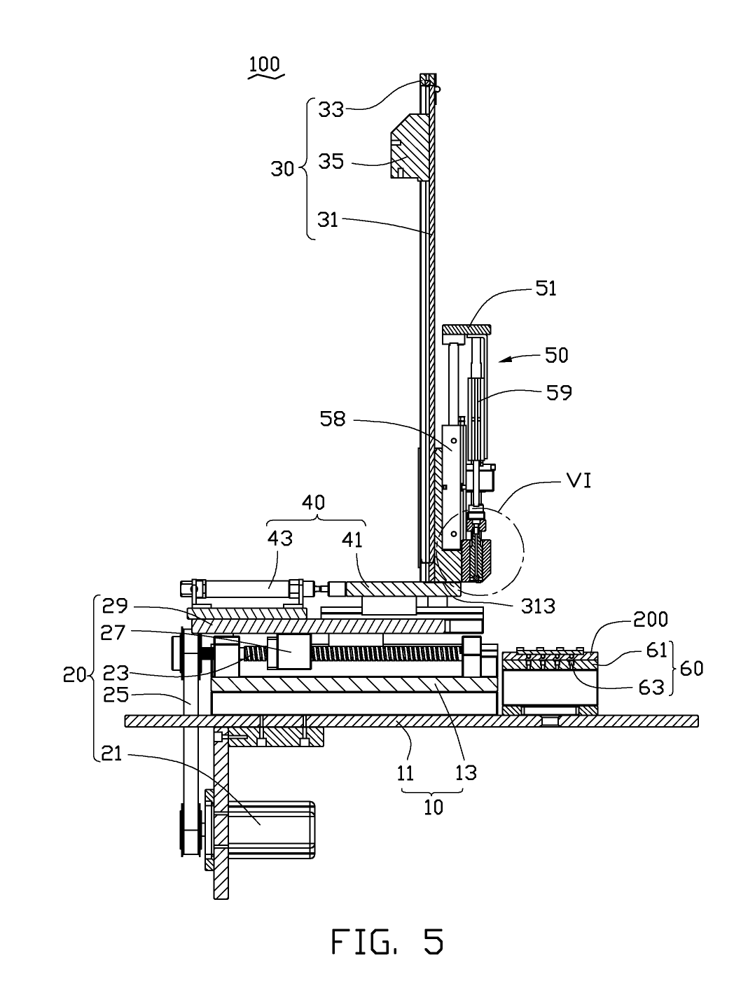

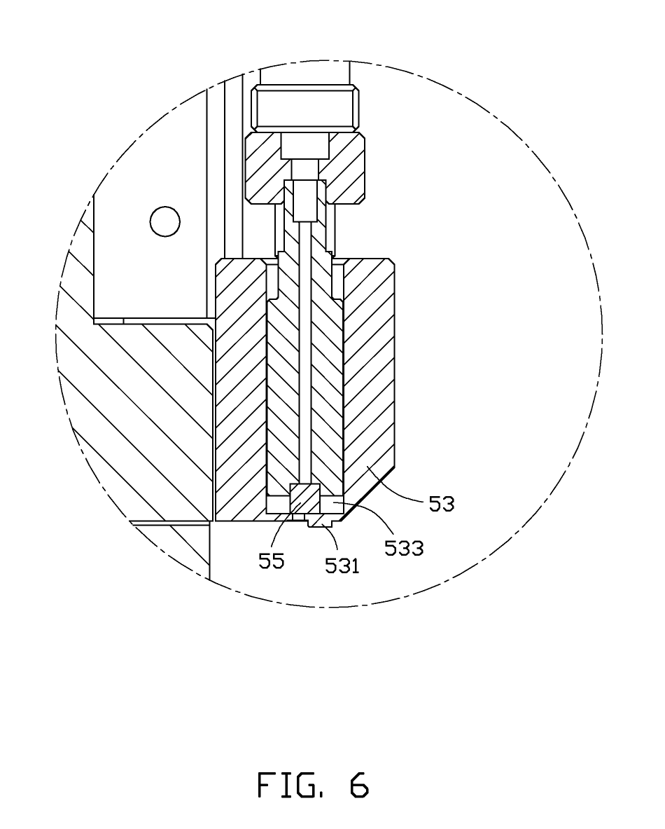

Referring to FIGS. 5 and 6, the loading assembly 50 includes a bracket 51, a loading member 53, a plurality of magnetic members 55, a plurality of liking rods 57, a first driving unit 58 and a second driving unit 59. The bracket 51 is mounted on the base member 29. The clamping plate 31 is mounted on the bracket 51. The loading member 53 is mounted on the bracket 51 adjacent the resisting space 313 and includes a plurality of blocking portions 531 arranged in a line. The plurality of blocking portions 531 blocks an end of the resisting space 313. The loading member 53 further defines a plurality of the receiving holes 533 at a side opposite to the plurality of blocking portions 531. The plurality of magnetic members 55 are respectively received in the plurality of receiving holes 533. Each of the linking rods 57 is connected to corresponding one magnetic member 55 with an end, an opposite end of the linking rod 57 is connected to the second driving unit 59. The second driving unit 59 is mounted on a middle portion of the bracket 51 to drive the magnetic members 55 out of the receiving holes 533. The first driving unit 58 is mounted on the bracket 51 to drive the loading member 53 away from the base member 29. In the embodiment, the magnetic member 55 is a strong magnet.

The sucking assembly 60 includes a mounting plate 61 and a plurality of magnets 63. The mounting plate 61 is parallel to and fixed to the bottom plate 11. The mounting plate 61 defines a plurality of receiving grooves (not labeled). The plurality of magnets 63 are respectively received in the plurality of receiving grooves for absorbing the plurality of permanent magnets. In the embodiment, the magnet 63 is strong magnet.

When in assembly, the transmission assembly 20 is mounted on the bottom plate 11. The resisting plate 41 and the driving member 43 are mounted on the base member 29 of the transmission assembly 20 and spaced from each other. The transferring assembly 30 is mounted on the bracket 51 and the bracket 51 is fixed to the base member 29. The first driving unit 58 and the second driving unit 59 are mounted on the bracket 51. The loading member 53 is mounted on an end of the bracket 51 and connected to the first driving unit 58. The linking rod 57 is connected to the second driving unit 59 and corresponding one magnetic member 55 by opposite ends thereof. The mounting plate 61 is mounted on the bottom plate 11. The plurality of magnets 63 are respectively mounted in the plurality of receiving grooves of the mounting plate 61.

When in use, the plurality of permanent magnets are mounted in the plurality of the clamping grooves 311 of the clamping plate 31. The permanent magnets received in a bottom of the clamping groove 311 are partially received in the resisting space 313. Workpieces are placed upon the mounting plate 61 with the plurality of receiving portions 202 thereof above the plurality of receiving grooves. The resisting plate 41 is moved to the clamping plate 31 at the urging of the driving member 43, and resists the permanent magnets toward the loading member 53. The permanent magnets are blocked by the plurality of blocking portions 531 of the loading member 53 and the transmission assembly 20 moves the bracket 51 toward the mounting plate 61. When the permanent magnets are aligned to the receiving portions 202, the first driving unit 58 drives the loading member 53 toward the mounting plate 61, the second driving unit 59 drives the magnet members 55 away from the mounting plate 61, such that the permanent magnets are released by the magnet members 55 and absorbed by the magnets 63, then located in the receiving portions 202.

The press-fit mechanism 100 places the permanent magnets on the workpieces 200 via the resisting assembly 40 and the loading assembly 50 automatically, thereby improving efficiency of mounting. Interferences between the permanent magnets are prevented. The plurality of clamping blocks 35 and the plurality of clamping grooves 311 employed here are press coverable of enhancing the mounting efficiency. The press cover 33 is equipped with a plurality of strong magnets, each strong magnet has a same polarity with the plurality of permanent magnets received in corresponding one clamping groove 311, thereby reducing the mounting error.

The number of the clamping blocks 35 may be changed to meet the requirement, such as one integrally clamping block 35 with a plurality of clamping portions respectively received in the plurality of clamping grooves 311. The number of the clamping grooves 311 may be changed according to the lines of the receiving portions 202 of the workpiece 200. The shape of the receiving portion 202 of the workpiece 200 may be changed into others shape to facilitate the permanent magnets to be received, such as rectangular groove. The permanent magnets which are received in the plurality of the receiving portions 202 may be other magnetic materials, such as briquettes. If so, the strong magnet equipped in the press cover 33 should be omitted.

The clamping plate 31 may be detachably mounted on the bracket 51, when the permanent magnets received in the clamping plate 31 are run out of. The clamping plate 31 may be exchanged by another clamping plate 31 receiving a plurality of permanent magnets therein.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A press-fit mechanism capable of mounting magnetic materials on a workpiece, comprising:
a base plate;
a transmission assembly slidably mounted on the base plate;
a resisting assembly and a loading assembly mounted on the transmission assembly, the resisting assembly comprising a driving member and a resisting plate connected to the driving member;
a transferring assembly located between the resisting assembly and the loading assembly; and
a sucking assembly mounted on the base plate and configured to support the workpiece, wherein the transferring assembly is configured to receive magnetic materials, the driving member drives the resisting plate to resist the magnetic materials toward the loading assembly, the loading assembly sucks the magnetic materials and is driven by the transmission assembly toward the sucking assembly until the magnetic materials is aligned to the workpiece then the loading assembly releases the magnetic materials, the sucking assembly sucks the magnetic materials and places the magnetic materials on the workpiece.

2. The press-fit mechanism of claim 1, wherein the transferring assembly comprises a clamping plate, a press cover and a plurality of clamping blocks, the clamping plate is perpendicular to and fixed to the transmission assembly, the clamping plate defines a plurality of the clamping grooves extending perpendicularly toward the transmission assembly, the plurality of clamping grooves are configured to receive the magnetic materials, each of the plurality of clamping blocks is received in each of the plurality of clamping grooves and presses the magnetic materials.

3. The press-fit mechanism of claim 2, wherein the press cover is detachably mounted on a top end of the clamping plate opposite to the transmission assembly, the press cover is equipped with a plurality of strong magnets correspondingly located relative to the plurality of clamping grooves, the clamping plate is made of non-magnetic materials, each of the plurality of strong magnets has a same polarity as a plurality of permanent magnets received in corresponding one of the plurality of clamping grooves.

4. The press-fit mechanism of claim 2, wherein the press cover is detachably mounted on a top end of the clamping plate opposite to the transmission assembly, the clamping plate and the transmission assembly cooperatively form a resisting space therebetween, and the resisting space communicates with the plurality of the clamping grooves.

5. The press-fit mechanism of claim 4, wherein the resisting plate defines a plurality of peeling grooves at an end thereof communicating with the resisting space, each of the plurality of peeling grooves is a stepped groove configured to receive a portion of one of the magnetic materials, a depth of each of the plurality of peeling grooves is greater than half of height of the magnetic materials.

6. The press-fit mechanism of claim 5, wherein the loading assembly comprises a bracket, a loading member, and a first driving unit, the bracket is mounted on transmission assembly, the clamping plate is mounted on the bracket, the loading member is mounted on the bracket adjacent to the resisting space and comprises a plurality of blocking portions arranged in a line, the plurality of blocking portions are configured to block ends of the magnetic materials resisted by the resisting plate, the first driving unit is mounted on the bracket, the first driving unit is configured to drive the loading member away from the transmission assembly.

7. The press-fit mechanism of claim 6, wherein the loading assembly further comprises a plurality of magnetic members, a plurality of liking rods, and a second driving unit, the loading member further defines a plurality of receiving holes at a side opposite to the plurality of blocking portions, each of the plurality of magnetic members is respectively received in each of the plurality of receiving holes, each of the plurality of linking rods is connected to each of the plurality of magnetic members and to the second driving unit by opposite ends of the linking rod, the second driving unit is mounted on the bracket, the second driving unit is configured to drive the plurality of magnetic members away from the plurality of blocking portions.

8. The press-fit mechanism of claim 7, wherein the sucking assembly comprises a mounting plate and a plurality of magnets, the mounting plate is parallel to and fixed to the base plate, the plurality of magnets are respectively received in the mounting plate, the plurality of magnets are configured for absorbing the magnetic materials.

9. A press-fit mechanism capable of mounting magnetic materials on a workpiece, comprising:
a base plate;
a transmission assembly slidably mounted on the base plate;
a resisting assembly and a loading assembly mounted on the transmission assembly;
a transferring assembly between the resisting assembly and the loading assembly, the transferring assembly and the transmission assembly cooperatively form a resisting space therebetween; and
a sucking assembly mounted on the base plate and configured to support the workpiece, wherein the transferring assembly is configured to receives the magnetic materials, the resisting assembly resists the magnetic materials in the resisting space toward the loading assembly, the loading assembly sucks the magnetic materials and is driven by the transmission assembly toward the sucking assembly until the magnetic materials is aligned to the workpiece then the loading assembly releases the magnetic materials, the sucking assembly sucks the magnetic materials and places the magnetic materials on the workpiece.

10. The press-fit mechanism of claim 9, wherein the transferring assembly comprises a clamping plate, a press cover and a plurality of clamping blocks, the clamping plate is perpendicular to and fixed to the transmission assembly, the clamping plate defines a plurality of the clamping grooves extending perpendicularly toward the transmission assembly, the plurality of clamping grooves are configured to receive the magnetic materials, each of the plurality of clamping blocks is received in each of the plurality of clamping grooves and presses the magnetic materials.

11. The press-fit mechanism of claim 10, wherein the press cover is detachably mounted on a top end of the clamping plate opposite to the base plate, the press cover is equipped with a plurality of strong magnets correspondingly located relative to the plurality of clamping grooves, the clamping plate is made of non-magnetic materials, each of the plurality of strong magnets has a same polarity as a plurality of permanent magnets received in corresponding one of the plurality of clamping grooves.

12. The press-fit mechanism of claim 10, wherein the press cover is detachably mounted on a top end of the clamping plate opposite to the transmission assembly, the resisting space is defined between the clamping plate and the transmission assembly, and communicates with the plurality of the clamping grooves.

13. The press-fit mechanism of claim 12, wherein the resisting assembly comprises a driving member and resisting plate connected to the driving member, the resisting plate defines a plurality of peeling grooves at an end thereof communicating with the resisting space, each of the peeling grooves is a stepped groove configured for receiving a portion of one the magnetic material, a depth of each of the peeling grooves is greater than half of height of the magnetic material.

14. The press-fit mechanism of claim 13, wherein the loading assembly comprises a bracket, a loading member, and a first driving unit, the bracket is mounted on the transmission assembly, the clamping plate is mounted on the bracket, the loading member is mounted on the bracket adjacent the resisting space and comprises a plurality of blocking portions arranged in a line, the plurality of blocking portions are configured to block ends of the magnetic materials in the resisting space, the first driving unit is mounted on the bracket, the first driving unit is configured to drive the loading member away from the transmission assembly.

15. The press-fit mechanism of claim 14, wherein the loading assembly further comprises a plurality of magnetic members, a plurality of liking rods, and a second driving unit, the loading member further defines a plurality of the receiving holes at a side opposite to the plurality of blocking portions, each of the plurality of magnetic members is respectively received in each of the plurality of receiving holes, each of the plurality of linking rods is connected to each of the plurality of magnetic members and the second driving unit by opposite ends of the linking rod, the second driving unit is mounted on the bracket, the second driving unit is configured to drive the plurality of magnetic members away from the plurality of blocking portions.

16. The press-fit mechanism of claim 15, wherein the sucking assembly comprises a mounting plate and a plurality of magnets, the mounting plate is parallel to and fixed to the base plate, the plurality of magnets are respectively received in the mounting plate, the plurality of magnets are configured for absorbing the magnetic materials.
